(19) United States
(12) Patent Application Publication
(10) Pub. No.: US 2020/0369351 A1
(43) Pub. Date: Nov. 26, 2020

(54) MARINE DOCKING AND OBJECT AWARENESS SYSTEM

(71) Applicant: Garmin Switzerland GmbH, Schaffhausen (CH)

(72) Inventors: Thomas G. Behrendt, Paola, KS (US); Michael T. Fickenscher, Overland Park, KS (US); Clifford S. Hofman, Cary, NC (US); Chun Wei Lin, New Taipei City (TW); Mei Huei Lin, New Taipei City (TW)

(21) Appl. No.: 15/929,754

(22) Filed: May 20, 2020

Related U.S. Application Data
(60) Provisional application No. 62/852,550, filed on May 24, 2019.

(51) Int. Cl. B63B 49/00; G06K 9/00; G06T 7/292; G06T 7/246; G06T 11/60; G08G 3/02; B63B 79/10

(52) U.S. Cl. CPC B63B 49/00; G06K 9/00664; G06T 7/292; G06T 7/246; G06T 2207/30241; G08G 3/02; B63B 79/10; G06T 2207/30261; G06T 11/60

(57) ABSTRACT

A marine docking and awareness system for facilitating docking and otherwise maneuvering vessels in marine environments. A navigation system may include a plurality of directional cameras and an image processing computer. Each directional camera generates images of the marine environment in a particular direction. The image processor processes the images from the cameras, including enhancing the images in accordance with various features. The features may include identifying and highlighting water and/or objects, adding distance markers, predicting and warning of collisions with objects, defining and adding virtual boundaries around the vessel and warning when an object crosses a boundary, automatically selecting the most relevant cameras based on the direction of movement or on an object crossing a boundary, combining multiple images from different cameras into an image, and displaying desired, projected, and historical tracks.

### RELATED APPLICATIONS

The present U.S. non-provisional patent application relates to and claims priority benefit of an earlier-filed U.S. provisional patent application titled “Marine Docking System,” Ser. No. 62/852,550, filed May 24, 2019. The entire content of the identified earlier-filed application is incorporated by reference as if fully set forth herein.

### BACKGROUND

Docking and other close-quarter maneuvering of boats, ships, and other vessels can be difficult for the inexperienced. Adverse conditions such as strong winds or currents, poor lighting, the presence of other vessels or objects, poor field of vision (especially for larger vessels), and poor maneuverability (especially for vessels without thrusters or forward motors) can make docking and maneuvering even more challenging.

Even those with significant experience parking and driving land vehicles may find piloting marine vessels much more difficult because, unlike land vehicles, marine vessels can move in and are subject to objects approaching from any direction in a three hundred sixty degree circle. For example, unlike a car, a boat is subject to drifting into objects and to objects drifting into it. This can present significant challenges even on relatively small boats for which it is difficult but at least physically possible to see the environment around the boat, but is much more difficult on relatively large ships for which it is not.

### SUMMARY

Embodiments provide a system for generating, enhancing, and displaying electronic images of objects to facilitate manually docking and otherwise maneuvering, especially close-quarter maneuvering, boats, ships, and other vessels in marine environments. Embodiments advantageously facilitate users, especially inexperienced users, maneuvering a vessel under such adverse and otherwise challenging conditions as strong winds or currents, poor lighting, the presence of other boats, ships, or objects, poor fields of vision, or poor maneuverability.

In an embodiment, a navigation system is provided for assisting a user in maneuvering a vessel, and may comprise an image processing computer, a display device, and a user interface. The image processing computer may be configured to receive and process at least a first image generated by at least one camera mounted on the vessel, detect and identify water and at least a first object in the first image, and highlight the first object in the first image. The display device may be configured to selectively display the first image processed by the image processing computer. The user interface may be configured to allow the user to provide input to the image processing computer and the display device with regard to the display of the first image.

Various implementations of the foregoing embodiment may include any one or more of the following additional features. The at least one camera may be a plurality of cameras including a plurality of directional cameras, wherein each directional camera is mounted in a particular position on the vessel and oriented in a particular direction and configured to generate directional images of the marine environment in the particular direction, an overhead camera mounted on an elevated position on the vessel and oriented downwardly and configured to generate overhead images of the vessel and the marine environment surrounding the vessel, and/or a virtual overhead image of the vessel created by transforming and stitching together images from a plurality of directional cameras.

The image processing computer may be further configured to highlight the water and/or highlight objects that are not water in the first image displayed on the display device. The image processing computer may be further configured to determine a speed and direction of movement of the first object relative to the vessel, and may be further configured to communicate a warning to the user when the speed and direction of movement of the first object indicates that the object will strike the vessel. The image processing computer may be further configured to add a plurality of markers indicating a plurality of distances in the first image displayed on the display device. The image processing computer may be further configured to determine a direction of movement of the vessel and to automatically display the first image generated by the at least one camera oriented in the direction of movement. The image processing computer may be further configured to define a virtual boundary and to add the virtual boundary at a specified distance around the vessel to the first image displayed on the display device, and may be further configured to determine and communicate a warning to the user when the first object crosses the virtual boundary, and may be further configured to automatically display the first image generated by the at least one camera oriented in the direction of the first object. The image processing computer may be further configured to combine two or more images generated by two or more of the cameras to create a combined image. The image processing computer may be further configured to determine a velocity vector of the vessel and to add an indication of the velocity vector to the first image displayed on the display device. The image processing computer may be further configured to determine a projected track of the vessel and to add an indication of the projected track to the first image displayed on the display device, and may be further configured to record a track history of the vessel and to add an indication of the track history to the first image displayed on the display device.

This summary is not intended to identify essential features of the present invention and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a fragmentary plan view of an embodiment of a system for generating, enhancing, and displaying images of nearby objects to assist in the manual docking or other maneuvering of a vessel, and an example marine environment in which the system may operate;

FIG. 2 is a block diagram of the system of FIG. 1;

FIG. 3 is a display of camera images showing an overhead view and a first directional view of the vessel and the example marine environment, wherein the images have been enhanced by adding first distance markers around the vessel;

FIG. 4 is a display of camera images showing an overhead view and a second directional view of the vessel and the example marine environment, wherein the images have been enhanced by adding second distance markers around the vessel;

FIG. 5 is a display of camera images showing an overhead view and a first directional view of the vessel and the example marine environment, wherein the images have been enhanced by highlighting water and non-water objects around the vessel;

FIG. 6 is a display of camera images showing an overhead view and a second directional view of the vessel and the example marine environment, wherein the images have been enhanced by highlighting water and non-water objects around the vessel;

FIG. 7 is a display of a camera image showing an overhead view of the vessel and the example marine environment, wherein the image has been enhanced by adding boundaries around the vessel; and

FIG. 8 is a display of a camera image showing an overhead view of the vessel and the example marine environment, wherein the image has been enhanced by changing a color of a boundary which has been crossed by an object.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly, embodiments provide a system for generating, enhancing, and displaying electronic images of objects to facilitate manually docking and otherwise maneuvering, especially close-quarter maneuvering, boats, ships, and other vessels in marine environments. Embodiments advantageously facilitate users, especially inexperienced users, maneuvering a vessel under such adverse and otherwise challenging conditions as strong winds or currents, poor lighting, the presence of other boats, ships, or objects, poor fields of vision (especially for larger boats and ships), or poor maneuverability (especially for vessels without thrusters or forward motors). As used herein, “marine” shall refer to substantially any aquatic environment, including so-called “brown” or “blue” water environments, such as rivers, lakes, coastal areas, seas, and oceans.

In an embodiment of the system operating in an example marine environment, a vessel may include one or more motors, a control system, and a navigation system. The motors may be configured to drive and maneuver the vessel through the marine environment, and the control system may be configured to facilitate a user controlling the movement and orientation of the vessel, including controlling operation of the motors. The navigation system may be configured to inform the user with regard to operating the control system, including with regard to maneuvering the vessel for docking and to avoid objects in the marine environment.

In addition to various navigation technologies such as mapping, routing, weather, radar, sonar, autopilot control, communications, and the like, embodiments of the navigation system may include, be operationally connected to, or otherwise make use of one or more directional cameras, an overhead camera, an image processing computer, a display device, and a user interface. Each directional camera may be mounted in a particular position on the vessel and oriented in a particular direction and configured to generate electronic images of the marine environment in the particular direction. The overhead camera may be mounted on a mast or other elevated point on the vessel and oriented downwardly and configured to generate images of the vessel and the marine environment surrounding the vessel. The image processing computer may be configured to receive and process the images from any or all of the directional and overhead cameras. The image processing computer may transform and stitch together the images from the directional cameras to create a virtual overhead image. The display may be a chartplotter or other electronic display configured to display the processed images, and the user interface may be configured to allow the user to provide input regarding operation of some or all of the other components of the navigation system.

In various implementations, the navigation system may be configured to provide any one or more of the following features to inform the user. An object identification feature may detect and identify objects in the images, and may visually highlight the detected and identified objects in displayed images. A distance marker feature may add markers indicating distance in the displayed images. A collision prediction feature may determine the relative speeds and directions of movement of the objects and the vessel, and communicate a warning when the relative speed and direction of movement indicates that a particular object and the vessel will collide. An automatic camera selection feature may determine a direction of movement of the vessel and automatically display the image generated by the directional camera oriented in the determined direction of movement. A virtual boundary feature may define a virtual boundary and add the virtual boundary to a displayed image at a specified distance around the vessel, and may determine and communicate a warning when a particular object crosses the virtual boundary. Relatedly, the system may automatically display the image from the directional camera oriented in the direction of the particular object. An image combining feature may combine multiple images from different cameras to create a combined image. A virtual overhead image may be created by transforming and combing multiple images from different cameras. A track display feature may determine a velocity vector and a projected track and may record a track history of the vessel and may add some or all of this information to a displayed image. All overlays (i.e. object highlights, virtual boundaries, distance markers) on individual camera images, combined images and virtual overhead images may be synchronized between the different views to have the same overlays simultaneously shown on a display or multiple displays from different points of view.

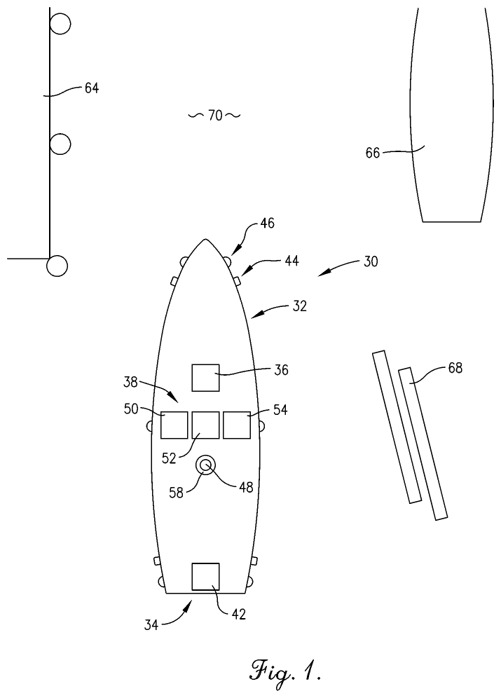

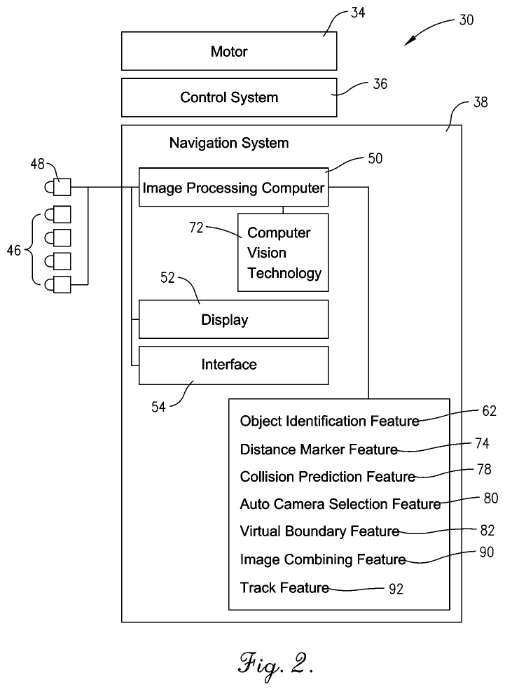

Referring to FIGS. 1 and 2, an embodiment of a system 30 is shown for generating, enhancing, and displaying electronic images of objects to facilitate manually docking and otherwise maneuvering, especially close-quarter maneuvering, a vessel 32 in an example marine environment. Although shown in the figures as a medium-sized boat, the vessel 32 may be substantially any boat, ship, or other vehicle configured to travel in, on, or over water, including substantially any suitable size, type, and overall design, and which would benefit from the system 30. In one implementation of the system 30 and elements of an example operational marine environment, the vessel 32 may include one or more motors 34, a control system 36, and a navigation system 38. Control system 36 and navigation system 38 may be integrated or provided as discrete components.

The one or more motors 34 may be configured to drive and maneuver the vessel 32 through the marine environment. In one implementation, the motors 34 may include a primary motor 42 configured to provide a primary propulsive force for driving the vessel 32, especially forwardly, through the marine environment. In one implementation, the primary motor 42 may be mounted to a rear portion (e.g., stern or transom) of the vessel 32. The motors 34 may further include one or more secondary motors 44 configured to provide a secondary propulsive force for steering or otherwise maneuvering the vessel 32 through the marine environment. The secondary motors 44 may be used with the primary motor 42 to enhance steering, or without the primary motor 42 when maneuvering the vessel 32 in situations that require relatively higher precision (e.g., navigating around other boats or other obstacles and/or in relatively shallow water). The secondary motors 44 may be used to steer the vessel 32 and/or may be used to maintain the vessel 32 at a substantially fixed position and/or orientation in the water. In various implementations, the secondary motors 44 may be mounted to any suitable portion of the vessel 32 (e.g., at or near a bow, stern, and/or starboard or port side of the vessel 32) depending on the natures of the secondary motors 44 and the vessel 32. The motors 34 may employ substantially any suitable technology for accomplishing their stated functions, such as gasoline, diesel, and/or electric technologies. In embodiments, secondary motors 34 are configured as hull thrusters. 46

The control system 36 may be configured to facilitate a user controlling the movement and orientation of the vessel 32. Depending on the design of the vessel 32, this may include controlling the amount of thrust provided by and/or the orientation of some or all of the motors 34 and/or a position of a rudder or other control surfaces. The control system 36 may employ substantially and suitable technology for accomplishing its stated functions, such as various wired and/or wireless controls.

The navigation system 38 may be configured to inform the user with regard to operating the control system 36, including with regard to maneuvering the vessel 32 for docking and to avoid objects in the marine environment. The navigation system 38 may employ substantially any suitable technology for accomplishing its stated functions, such as various conventional navigational technologies.

For example, by way of navigational technologies, the navigation system 38 may include one or more sensors for detecting an orientation, change in orientation, direction, change in direction, position, and/or change in position of the vessel 32. In one implementation, the navigational system 38 may include a location determining component that is configured to detect a position measurement for the vessel 32 (e.g., geographic coordinates of at least one reference point on the vessel 32, such as a motor location, vessel center, bow location, stern location, etc.). In one implementation, the location determining component may be a global navigation satellite system (GNSS) receiver (e.g., a global positioning system (GPS) receiver, software defined (e.g., multi-protocol) receiver, or the like). In one implementation, the navigation system 38 may be configured to receive a position measurement from another device, such as an external location determining component or from at least one of the motors 34. Other positioning-determining technologies may include a server in a server-based architecture, a ground-based infrastructure, one or more sensors (e.g., gyros or odometers), a Global Orbiting Navigation Satellite System (GLONASS), a Galileo navigation system, and the like.

In one implementation, the navigation system 38 may include a magnetometer or GNSS heading sensor configured to detect an orientation measurement for the vessel 32. For example, the magnetometer or GNSS heading sensor may be configured to detect a direction in which the bow of the vessel 32 is pointed and/or a heading of the vessel 32. In one implementation, the navigation system 38 may be configured to receive an orientation measurement from another device, such as an external magnetometer, an external GNSS heading sensor, a location determining device, and/or the motors 34. In one implementation, the navigation system 38 may include or be communicatively coupled with at least one inertial sensor (e.g., accelerometer and/or gyroscope) for detecting the orientation or change in orientation of the vessel 32. For example, an inertial sensor may be used instead of or in addition to the magnetometer or GNSS heading sensor to detect the orientation.

The navigation system 38 may include a processing system communicatively coupled to the location and orientation determining components and configured to receive the position and orientation measurements and to control the integration and other processing and display of this and other navigational information, and may perform other functions described herein. The processing system may be implemented in hardware, software, firmware, or a combination thereof, and may include any number of processors, controllers, microprocessors, microcontrollers, programmable logic controllers (PLCs), field-programmable gate arrays (FPGAs), application specific integrated circuits (ASICs), or any other component or components that are operable to perform, or assist in the performance of, the operations described herein. Various features provided by the processing system, and in turn the navigation system 38, may be implemented as software modules that are executable by the processing system to provide desired functionality.

The processing system may also be communicatively coupled to or include electronic memory for storing instructions or data. The memory may be a single component or may be a combination of components that provide the requisite storage functionality. The memory may include various types of volatile or non-volatile memory such as flash memory, optical discs, magnetic storage devices, SRAM, DRAM, or other memory devices capable of storing data and instructions.

In addition to the foregoing components, the navigation system 38 may include, be operationally connected to, or otherwise make use of one or more cameras, such as one or more directional cameras 46 and/or an overhead camera 48, an image processing computer 50, a display device 52, and a user interface 54. Each of computer 50, display 52, and user interface 54 may be integrated within a common housing, such as in embodiments where navigation system 38 is a chartplotter. In other configurations, computer 50, display 52, and/or interface 54 may be configured as discrete elements that use wired or wireless communication techniques to interface with various components of system 30.

Each directional camera 46 may be mounted in a particular position on the vessel 32 and oriented in a particular direction and configured to generate electronic images of the marine environment in the particular direction. In one implementation, the directional cameras 46 may be sufficient in their number and orientations to provide up to three hundred sixty degrees of image coverage of the marine environment around the vessel 32. The overhead camera 48 may be mounted on a mast or other elevated point 58 on the vessel 32 and oriented downwardly and configured to generate images of the vessel 32 and the marine environment surrounding the vessel 32. The directional and overhead cameras 46, 48, may employ substantially any suitable technology to generate image data of substantially any suitable nature, such as optical, radar, lidar, and/or infrared.

The image processing computer 50 may be part of the aforementioned processing system and may be configured to receive and process the generated images from the directional and overhead cameras 46, 48. The image processing computer 50 may include a processor and an electronic memory as described above. Various functions which may be performed by the image processing computer 50 are described in greater detail below.

The display 52 may be communicatively coupled with the image processing computer 50 and may be configured to display the processed images. In various implementations, a single image from a single camera 46, 48 may be individually displayed, multiple images from multiple cameras 46, 48 may be simultaneously displayed, and/or images from selected cameras 46, 48 may be displayed individually or simultaneously. Further, as discussed below, multiple images from different cameras 46, 48 may be combined into a single image and displayed. The display may employ substantially any suitable technology for accomplishing its stated functions, such as liquid crystal display (LCD), light-emitting diode (LED) display, light-emitting polymer (LEP) display, thin film transistor (TFT) display, gas plasma display, or any other type of display. The display 52 may be backlit such that it may be viewed in the dark or other low-light environments. The display 52 may be of any size and/or aspect ratio. In one implementation, the display 52 may include touchscreen technology, such as resistive, capacitive, or infrared touchscreen technologies, or any combination thereof. In one implementation, the display 52 may be a chartplotter which integrates and displays position data with electronic navigational charts.

The user interface 54 may be configured to allow the user to provide input regarding operation of some or all of the other components of the navigation system 38. The user interface 54 may employ substantially and suitable technology for accomplishing its stated functions, such as electromechanical input devices (e.g., buttons, switches, toggles, trackballs, and the like), touch-sensitive input devices (e.g., touchpads, touch panels, trackpads, and the like), pressure-sensitive input devices (e.g., force sensors or force-sensitive touchpads, touch panels, trackpads, buttons, switches, toggles, trackballs, and the like), audio input devices (e.g., microphones), cameras (e.g., for detecting user gestures or for face/object recognition), or a combination thereof. In configurations, the user interface 54 is integrated with the display 52, such as in embodiments where the display 52 is configured as a chartplotter and the user interface 54 is configured to control the operation of the chartplotter through buttons, touch sensors, and/or other controls.

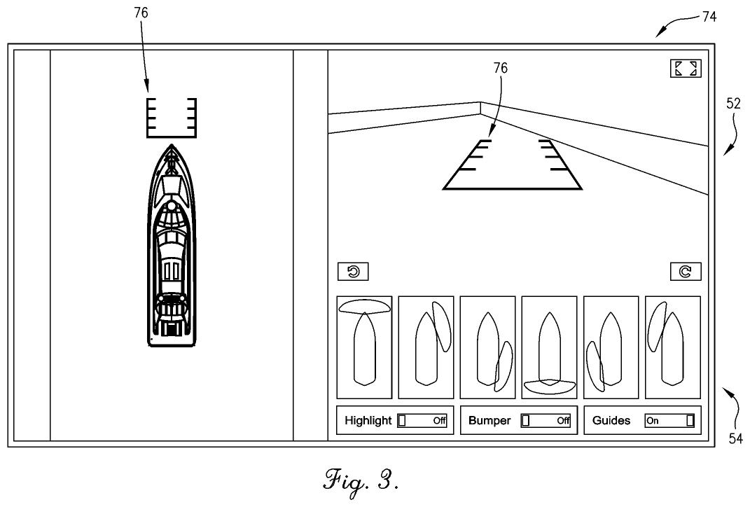

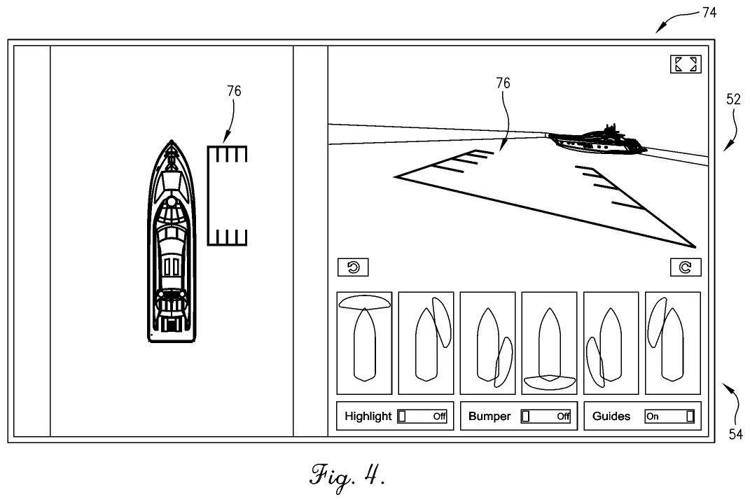

In various implementations, the navigation system 38 may be configured to provide any one or more of the following features to inform the user with regard to operating the control system 36. Referring also to FIGS. 3 and 4, the system 38 may include an object identification feature (module) 62 which may be configured to detect and identify objects in the images. As seen in FIG. 1, objects may include substantially any relevant objects or categories of objects such as docks 64, shores, rocks, buoys, other boats 66, and debris 68 (e.g., logs). The object identification feature 62 may be further configured to detect and identify the water 70 itself (or non-water) in the images in order to better distinguish between the water 70, non-water, and/or objects 64, 66, 68 in or around the water. In one implementation, discussed in greater detail below, the system 38 may employ an artificial intelligence module 72 in the form of, e.g., machine learning, computer vision, or neural networks trained with water, non-water objects, and boats in order to learn to reliably identify and distinguish between the objects and the water. In alternative implementations, the system 38 may specifically identify individual objects by type or may merely distinguish between objects and water. In one implementation, in which the object is a dock 64, this feature may include providing a detailed docking view for the user. In such configurations, the system 38 may be calibrated along the dock of interest.

The system 38 may be further configured to visually highlight the objects in displayed images to facilitate awareness by the user. For example, water 70 may be highlighted bright blue or another color, non-water may be highlighted another color, and/or non-water objects 64, 66, 68 may be highlighted yellow or another color. In one implementation, the user may be allowed to select the highlight colors, what objects are highlighted, whether and how water and non-water are highlighted, and how objects are highlighted. Object detection and highlighting may be performed on a pixel-by-pixel basis to allow clear differentiation between objects and water. In one implementation, seen in FIGS. 3 and 4, the display device 52 may display a first particular image, for example a virtual overhead image generated by combining images from one or more directional cameras 46, in which objects 64,66,68 and water 70 may be highlighted, and may simultaneously display a second particular image from a user-selected or automatically selected directional camera 46 in which objects and/or water may or may not be highlighted (FIGS. 4 and 3, respectively). The user may be allowed to enable and disable this feature 62 or any particular aspect or implementation of this feature as desired or needed.

As mentioned, in one implementation, data from an image may be processed using an artificial intelligence computer vision module 72 to identify one or more objects in the image, the vessel itself, and the water. The computer vision technology may include a machine learning model, such as a neural network, trained to perform object detection and/or image segmentation to identify the location of one or more objects in the image data received from the one or more cameras. Object detection may involve generating bounding boxes around objects. Image segmentation may provide greater granularity by dividing the image into segments, with each segment containing pixels that have similar attributes. In semantic segmentation every pixel is assigned to a class, and every pixel of the same class is represented as a single instance with a single color, while in instance segmentation different objects of the same class are represented as different instances with different colors.

One example technique for segmenting different objects is to use region-based segmentation in which pixels falling above or below a threshold are classified differently. With a global threshold, the image is divided into object and background by a single threshold value, while with a local threshold, the image is divided into multiple objects and background by multiple thresholds. Another example technique is to use edge detection segmentation which uses the discontinuous local features in any image to detect edges and thereby define the boundary of the object. Another example technique is to use cluster-based segmentation in which the pixels of the image are divided into homogeneous clusters. Another example technique, referred to as Mask R-CNN, provides a class, bounding box coordinates, and a mask for each object in the image. These or other techniques, or combinations thereof, may be used by the system 38 to identify objects in the images. Such a configuration allows the system 38 to be trained to identify desired object types and provide specific feedback for each identified object types. In embodiments, the user of system 38 may identify and label objects displayed on display 52 using interface 54 to update or retrain the computer vision module 72. For example, if the system 30 is not trained to identify an object that the user commonly encounters, the user may retrain the system 30 to automatically identify the object in the future by highlighting the object using user interface 54.

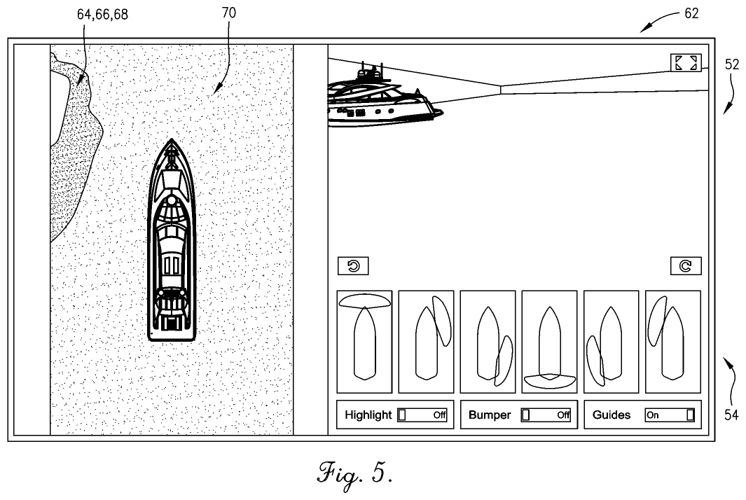

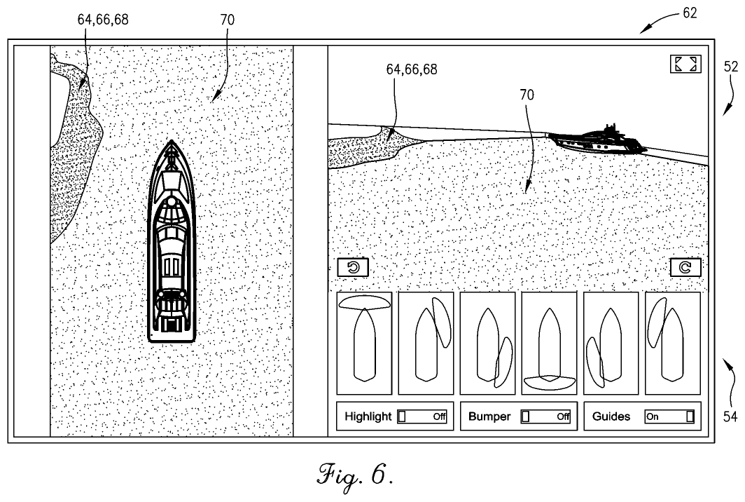

Referring also to FIGS. 5 and 6, the system 38 may include a distance marker feature (module) 74 which may be configured to overlay or otherwise incorporate into displayed images distance markers 76 providing scale and indicating distance to facilitate the user determining distances to objects. Lines and/or tick marks may communicate the dimensions and distances from the vessel 32 of other docks 64, other vessels 66, and other objects 68. The lines and/or tick marks may represent dimensions and distances of approximately between one meter and five meters in increments of one meter. In one implementation, seen in FIGS. 5 and 6, the display device 52 may display a first particular image from the overhead camera 48, and/or a virtual overhead image generated by combining or otherwise stitching together images from cameras 46, in which the distance markers 76 are added, and may simultaneously display a second particular image from a user-selected or automatically selected directional camera 46 in which the distance markers 76 may or may not be added. The user may be allowed to enable and disable this feature 74 or any particular aspect or implementation of this feature as desired or needed.

The system 38 may include a collision prediction feature (module) 78 which may be configured to determine relative speeds and directions of movement of other vessels 66 or other objects 68 and the vessel 32, and to communicate a warning when the relative speed and direction of movement indicates that a particular object 66, 68 and the vessel 32 will collide. Relatedly, the system 38 may be configured to automatically display the image from the directional camera 46 oriented in the direction of the particular object. In one implementation, a pop-up bug may appear in a portion of a displayed image related to the threat. The pop-up bug may be selectable by the user to cause to be displayed additional information about the object (e.g., identification, direction, velocity). The user may be allowed to enable and disable this feature 78 or any particular aspect or implementation of this feature as desired or needed.

The system 38 may include an automatic camera selection feature (module) 80 which may be configured to automatically select and display one or more images generated by one or more directional cameras 46 which are particularly relevant based on, e.g., the vessel's drive status or input or other considerations. For example, the system 38 may be configured to determine a direction of movement of the vessel 32 and automatically display the image generated by the particular directional camera 46 oriented in the determined direction of movement. In another example, movement rearward or aft may cause the system 38 to automatically display an image generated by a directional camera 46 oriented rearward. The direction of movement may be determined using, e.g., GPS, inertial, or other position- or motion-sensing technologies which may be part of the larger navigation system 38. The user may be allowed to enable and disable this feature 80 or any particular aspect or implementation of this feature as desired or needed. In some configurations, computer vision module 72 may detect objects and/or other features in images from a particular camera 46 and alert the system 38 to automatically display images from the particular camera 46 based on detected objects. For example, if the user is viewing images from a first camera on display 52, but module 72 detects an object on a second camera not currently being viewed by the user, the system 38 may transition to display of the second camera to ensure that the user is aware of the detected object.

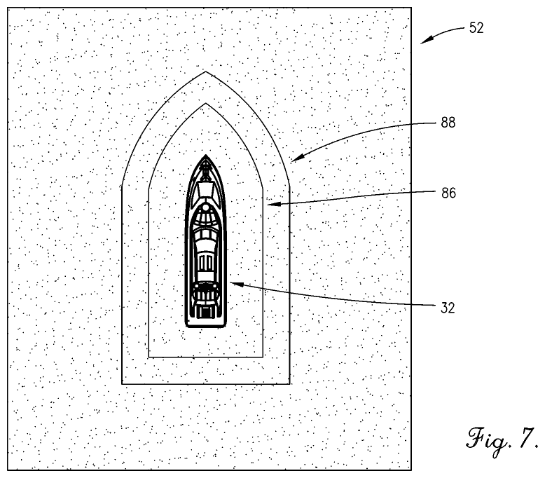

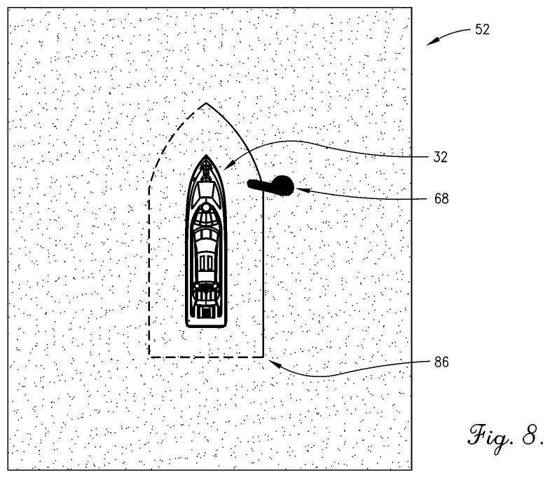

Referring also to FIGS. 7 and 8, the system 38 may include a virtual boundary feature (module) 82 which may be configured to define a virtual boundary 86 and overlay or otherwise incorporate the virtual boundary 86 into a displayed image at a specified distance around the vessel 32, and may be further configured to determine and communicate a warning when a particular object 68 crosses the virtual boundary 86. Relatedly, the system 38 may be configured to automatically display the image from the particular directional camera 46 oriented in the direction of the particular object.

In one implementation, seen in FIG. 7, the system 38 may be further configured to determine and display a second or more set of one or more boundaries 88 which are located at different distances from the vessel 32 than the first set of boundaries 86. Distances between the vessel 32 and each such boundary 86, 88 may be adjustable by the user. In one implementation, in which there are at least two sets of boundaries 86, 88, one or more of the boundaries may be configured to ignore object detection, while one or more of the boundaries may be configured to respond to object detection. In one implementation, seen in FIG. 8, each boundary 86, 88 may provide passive visual indicators of distances to objects 68. In another implementation, each boundary 86, 88 may actively change color entirely or locally (indicated by dashed and solid lines in FIG. 8) to indicate an object 68 breaking the boundary. In yet another implementation, the system may be configured to automatically communicate a visual and/or audible warning or other alert to the user of an object breaking a boundary, and, possibly, the size of, nature of (e.g., trash, log, rock, animal), and/or distance to the object.

The user may be allowed to enable and disable this feature 82 or any particular aspect or implementation of this feature as desired or needed. In one implementation, if the user has not enabled this feature 82, the system 38 may be configured to automatically enable this feature 82 when it detects an object at or within a user-specified distance from the vessel 32.

The system 38 may include an image combining feature (module) 90 which may be configured to combine multiple images from different cameras 46, 48 to create a single combined image for display. In one implementation, images from several or all of the cameras 46, 48 may be stitched together or otherwise combined and transformed to provide a three hundred sixty degree “overhead” view of the vessel 32 and its surroundings. In various implementations, the overhead view may be individually displayed, the overhead view may be simultaneously displayed with multiple images from multiple cameras 46, 48, and/or the overhead view may be selectable for individual or simultaneous display with images from selected cameras 46, 48. The user may be allowed to enable and disable this feature 90 or any particular aspect or implementation of this feature as desired or needed.

The system 38 may include a track feature (module) 92 which may be configured to determine a velocity vector and/or a projected track and/or to record a track history of the vessel 32, and to add some or all of this information to a displayed image. The system 38 may be further configured to similarly display a desired track, and may simultaneously display the desired and projected tracks. The user may be allowed to enable and disable this feature 92 or any particular aspect or implementation of this feature as desired or needed.

It will be understood that various implementations of the system 38 may provide any one or more of these features 62, 74, 78, 80, 82, 90, 92. In various implementations, the user may selectively enable and/or disable one or more the features, the system 38 may automatically enable and/or disable one or more of the features under relevant circumstances, and one or more of the features may be simultaneously employable. For example, the object identification feature 62 and the distance marker feature 74 may be simultaneously employed. For another example, the virtual boundary feature 82 and/or the collision prediction feature 78 and the automatic camera selection feature 80 may be simultaneously employed.

The user interface 54 enables the user to interact with system 38 based on information provided by the features described herein. For example, the user may select a labeled object on display 52 to mark as a waypoint (and/or obstacle) for future navigational reference. The system 38 may utilize these stored locations, and/or other cartographic locations stored within the memory of system 38, to automatically transition camera views as the vessel approaches known objects. The user may likewise select displayed objects for tracking and monitoring by system 38 regardless of the particular camera view selected by the user. Additionally or alternatively, the user may utilize the user interface 54 to select locations for automatic docking and navigation. For instance, a user may touch a desired location on a displayed image from one or more of the cameras, the system 38 may determine the geographic location corresponding to the desired location, and the system 38 may automatically navigate to the desired location using autopilot features and the detected object information. As one example, the user may select a displayed docking location presented on display 52 and the system 38 may automatically navigate to the docking location.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A navigation system to assist a user in maneuvering a vessel, the navigation system comprising:
an image processing computer configured to—
receive and process at least a first image generated by at least one camera mounted on the vessel,
detect and identify water and at least a first object in the first image, and
highlight the first object in the first image;
a display device configured to selectively display the first image processed by the image processing computer; and
a user interface configured to allow the user to provide input to the display device with regard to the display of the first image.

2. The navigation system of claim 1, further including the at least one camera, the at least one camera including a plurality of directional cameras configured to generate directional images of the marine environment in at least two directions.

3. The navigation system of claim 1, wherein the image processing computer is further configured to highlight the water in the first image displayed on the display device.

4. The navigation system of claim 1, wherein the image processing computer is further configured to determine a speed and direction of movement of the first object relative to the vessel.

5. The navigation system of claim 4, wherein the image processing computer is further configured to communicate a warning to the user when the speed and direction of movement of the first object relative to the vessel indicates that the first object and the vessel will collide.

6. The navigation system of claim 1, wherein the image processing computer is further configured to add a plurality of markers indicating a plurality of distances in the first image displayed on the display device.

7. The navigation system of claim 1, wherein the image processing computer is further configured to determine a direction of movement of the vessel and to automatically display the first image generated by the at least one camera oriented in the direction of movement.

8. The navigation system of claim 1, wherein the image processing computer is further configured to define a virtual boundary and to add the virtual boundary at a specified distance around the vessel to the first image displayed on the display device.

9. The navigation system of claim 8, wherein the image processing computer is further configured to determine and communicate a warning to the user when the first object crosses the virtual boundary.

10. The navigation system of claim 9, wherein the image processing computer is further configured to automatically display the first image generated by the at least one camera oriented in the direction of the first object.

11. The navigation system of claim 1, wherein the image processing computer is further configured to combine two or more images generated by two or more cameras to create a combined image.

12. The navigation system of claim 1, wherein the image processing computer is further configured to determine a velocity vector of the vessel and to add an indication of the velocity vector to the first image displayed on the display device.

13. The navigation system of claim 1, wherein the image processing computer is further configured to determine a projected track of the vessel and to add an indication of the projected track to the first image displayed on the display device.

14. The navigation system of claim 1, wherein the image processing computer is further configured to record a track history of the vessel and to add an indication of the track history to the first image displayed on the display device.

15. A navigation system to assist a user in maneuvering a vessel, the navigation system comprising:
an image processing computer configured to receive and process a plurality of images generated by a plurality of cameras mounted on the vessel, the image processing computer configured to—
detect and identify a first object in at least a first image of the plurality of images and highlighting the first object in the first image,
detect and identify water in the first image and highlighting the water in the first image, and
add a plurality of markers to the first image indicating a plurality of distances in the first image;
a display device configured to selectively display the plurality of images processed by the image processing computer, including the first image; and
a user interface configured to allow the user to provide input to the image processing computer and the display device with regard to how the plurality of images are processed and displayed, including the first image.

16. The navigation system of claim 15, the plurality of cameras including a plurality of directional cameras, wherein each directional camera is mounted in a particular position on the vessel and oriented in a particular direction and configured to generate directional images of the marine environment in the particular direction.

17. The navigation system of claim 15, wherein the image processing computer is configured to—
determine a speed and direction of movement of the first object relative to the vessel;
communicate a warning to the user when the speed and direction of movement of the first object relative to the vessel indicates that the first object and the vessel will collide; and
determine a direction of movement of the vessel and to automatically display the first image which is a directional image generated by a particular directional camera oriented in the direction of movement.

18. The navigation system of claim 15, wherein the image processing computer is configured to—
define a virtual boundary and to add the virtual boundary at a specified distance around the vessel to the first image displayed on the display device;
determine and communicate a warning to the user when the first object crosses the virtual boundary; and
automatically display the first image which is a directional image generated by a particular directional camera oriented in the direction of the first object.

19. The navigation system of claim 15, wherein the image processing computer is configured to—
determine a velocity vector of the vessel and to add an indication of the velocity vector to the first image displayed on the display device;
determine a projected track of the vessel and to add an indication of the projected track to the first image displayed on the display device; and
record a track history of the vessel and to add an indication of the track history to the first image displayed on the display device.

20. A navigation system to assist a user in maneuvering a vessel, the navigation system comprising:
a plurality of directional cameras, wherein each directional camera is mounted in a particular position on the vessel and oriented in a particular direction and configured to generate directional images of the marine environment in the particular direction; and
an image processing computer configured to receive and process a plurality of images generated by the plurality of cameras mounted on the vessel, the image processing computer configured to—
detect and identify a first object in a first image of the plurality of images and highlighting the first object in the first image,
detect and identify water in the first image and to highlight the water in the first image, and
add a plurality of markers indicating a plurality of distances in the first image,
communicate a warning to the user when a speed and direction of movement of the first object relative to the vessel indicates that the first object and the vessel will collide,
define a virtual boundary and to add the virtual boundary at a specified distance around the vessel to the first image, and communicate a warning to the user when the first object crosses the virtual boundary, and
determine a velocity vector of the vessel and to add an indication of the velocity vector to the first image displayed on the display device;
a display device configured to selectively display the plurality of images processed by the image processing computer, including the first image; and
a user interface configured to allow the user to provide input to the image processing computer and the display device with regard to how the plurality of images are processed and displayed, including the first image.
